(19) United States
(12) Patent Application Publication
(10) Pub. No.: US 2022/0278567 A1
(43) Pub. Date: Sep. 1, 2022

(54) MOTOR, DRIVE SYSTEM, VACUUM CLEANER, UNMANNED FLIGHT VEHICLE, AND ELECTRIC AIRCRAFT

(71) Applicant: Nidec Corporation, Kyoto (JP)

(72) Inventors: Tomokazu FUKUZAKI, Kyoto (JP); Shohei YOSHIDA, Kyoto (JP); Ryuji TAMURA, Tokyo (JP)

(21) Appl. No.: 17/634,562

(22) PCT Filed: Aug. 25, 2020
(86) PCT No.: PCT/JP2020/031958

§ 371 Date: Feb. 11, 2022

(30) Foreign Application Priority Data
Aug. 26, 2019 (JP) 2019-153704

(51) Int. Cl. H02K 1/02; H01F 1/057

(52) U.S. Cl. CPC H02K 1/02; H01F 1/057; A47L 5/28

(57) ABSTRACT

A motor includes a stator and a rotor rotatable about a central axis with respect to the stator, the rotor or the stator including a neodymium magnet including a material structure including a main phase with a composition represented by a composition formula: Nd—Fe—B and a grain boundary phase including an Nd concentration higher than an Nd concentration of the main phase, the grain boundary phase includes at least an alloy of Nd and an additive element M1, the additive element M1 is an element other than Fe and B, and an electrical resistivity of the neodymium magnet is equal to or greater than about 1.5 μΩm.

### CROSS-REFERENCE TO RELATED APPLICATIONS

This is a U.S. national stage of application No. PCT/JP2020/031958, filed on Aug. 25, 2020, and with priority under 35 U.S.C. § 119(a) and 35 U.S.C. § 365(b) being claimed from Japanese Patent Application No. 2019-153704, filed on Aug. 26, 2019, the entire disclosures of which are hereby incorporated herein by reference.

### 1. FIELD OF THE INVENTION

The present disclosure relates to a motor, a drive system, a vacuum cleaner, an unmanned flight vehicle, and an electric aircraft.

### 2. BACKGROUND

Conventionally, a rare earth permanent magnet is known as a permanent magnet used for a motor. There is known a manufacturing method for obtaining a high-resistance rare earth permanent magnet by performing discharge plasma sintering on a mixed powder of a magnet powder and a metalloid powder.

In the rare earth permanent magnet obtained by the manufacturing method, solid metalloid is disposed at a grain boundary between crystal grains of the magnet, so that there is a possibility that magnetic characteristics of the permanent magnet are adversely affected. When the permanent magnet described above is mounted on a motor, the torque of the motor decreases even if eddy current loss can be reduced, and as a result, there is a possibility that the permanent magnet does not contribute to improvement of the performance of the motor.

### SUMMARY

According to one example embodiment of the present disclosure, a motor includes a stator and a rotor rotatable about a central axis with respect to the stator, the rotor or the stator including a neodymium magnet, in which the neodymium magnet includes a material structure with a main phase including a composition represented by a composition formula: Nd—Fe—B and a grain boundary phase including an Nd concentration higher than an Nd concentration of the main phase, the grain boundary phase substantially includes an alloy of Nd and an additive element M1, the additive element M1 is an element other than Fe and B, and an electrical resistivity of the neodymium magnet is equal to or greater than about 1.5 μΩm.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an explanatory view illustrating a crystal structure of a neodymium magnet used in a motor according to an example embodiment of the present disclosure.

FIG. 2 is an explanatory view illustrating a manufacturing method of a neodymium magnet according to an example embodiment of the present disclosure.

FIG. 3 is a measurement result of element mapping of a neodymium magnet with diffused Ge according to an example embodiment of the present disclosure.

FIG. 4 is a cross-sectional view illustrating an example of a motor according to an example embodiment of the present disclosure.

FIG. 5 is a perspective view illustrating an example of a vacuum cleaner according to an example embodiment of the present disclosure.

FIG. 6 is a perspective view illustrating an example of an unmanned flight vehicle according to an example embodiment of the present disclosure.

### DETAILED DESCRIPTION

Example embodiments of the present disclosure will be described below with reference to the drawings.

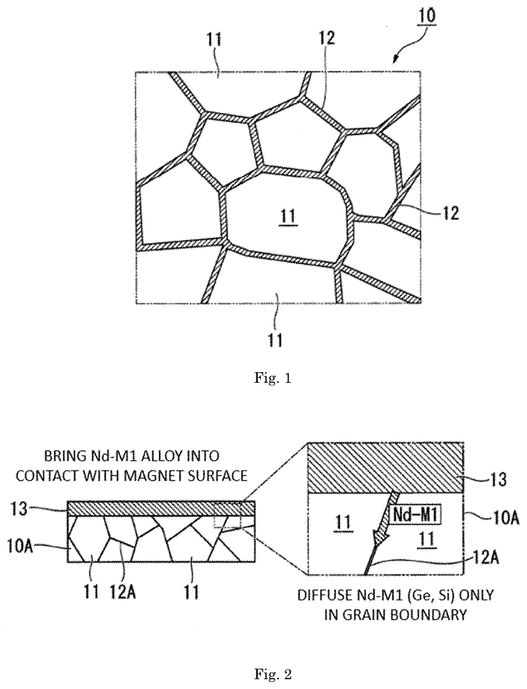

FIG. 1 is an explanatory view illustrating the crystal structure of a neodymium magnet used for a motor in the present example embodiment.

A neodymium magnet 10 has a material structure including a main phase 11 having a composition represented by a composition formula: Nd—Fe—B and a grain boundary phase 12 having an Nd concentration higher than an Nd concentration of the main phase 11.

The main phase 11 is a crystal phase of Nd₂Fe₁₄B alloy, for example. The grain boundary phase 12 is an Nd-rich crystal grain boundary phase surrounding the main phase 11 (crystal of Nd₂Fe₁₄B alloy). In the present example embodiment, the grain boundary phase 12 substantially includes an alloy of Nd and the additive element M1. The additive element M1 is at least one element selected from the group consisting of Si and Ge.

The neodymium magnet 10 of the present example embodiment is a sintered magnet manufactured by molding and sintering a raw material alloy having a particle size of several microns. By adjusting the Nd content in the raw material alloy, it is possible to adjust the volume of the grain boundary phase 12, and it is possible to adjust the magnetic characteristics of the obtained neodymium magnet 10. Specifically, the coercivity of the neodymium magnet 10 increases by increasing the ratio of the grain boundary phase 12. On the other hand, since the ratio of the main phase 11 becomes relatively low, the residual magnetic flux density and the maximum energy product of the neodymium magnet 10 tend to decrease.

In the neodymium magnet 10 of the present example embodiment, the additive element M1 contained in the grain boundary phase 12 is diffused and permeated from the surface of the neodymium magnet 10. In the present example embodiment, Si and Ge, which are metalloids, are used as the additive element M1. As shown in Examples to be described later, the neodymium magnet 10 having the grain boundary phase 12 containing the additive element M1 including these metalloids can increase the electrical resistivity without impairing the magnetic characteristics. Therefore, when using the neodymium magnet 10 of the present example embodiment for, for example, a motor, it is possible to reduce eddy current loss due to the high electrical resistivity. This can improve the motor efficiency, and can also suppress heat generation of the motor.

The electrical resistivity of the neodymium magnet 10 is equal to or greater than 1.5 [μΩm]. That is, the neodymium magnet of the present example embodiment has a higher electrical resistivity than that of a neodymium magnet to which the additive element M1 is not added. This configuration can reduce the eddy current loss as compared with a motor using a conventional neodymium magnet, and can provide a high-output motor.

The electrical resistivity of the neodymium magnet 10 is preferably equal to or greater than 2.0 [μΩm], and more preferably equal to or greater than 2.8 [μΩm]. By increasing the electrical resistivity of the neodymium magnet 10, it is possible to reduce the eddy current loss while maintaining the torque and output of the motor. By setting the electrical resistivity to 2.8 [μΩm], it is possible to reduce the eddy current loss to half as compared with a conventional neodymium magnet having an electrical resistivity of 1.4 [μΩm].

It is considered that in the neodymium magnet 10 of the present example embodiment, the magnetic characteristics are not deteriorated by the diffusion of the additive element M1 because the additive element M1 (Si, Ge) uniformly diffuses into the grain boundary phase 12, and the Nd-rich crystal phase structure of the grain boundary phase 12 is substantially maintained before and after the additive element M1 is diffused.

For example, when a sintered magnet is produced by adding Ge powder to a raw material alloy during sintering, a part of Ge diffuses into the crystal structure, but a fine structure in which Ge particles are localized in the grain boundary phase is obtained. In such a sintered magnet, the electrical resistivity rises due to diffusion of Ge, but the coercivity drops because a portion where the Ge crystal grains are segregated easily becomes a starting point of magnetization reversal. According to the neodymium magnet 10 of the present example embodiment, the electrical resistivity can be increased without causing the coercivity reduction as described above.

In the neodymium magnet of the present example embodiment, it is preferable that the grain boundary phase 12 includes an alloy of Nd and the additive element M1 in a proportion of equal to or greater than 85 atom %. According to this configuration, the grain boundary phase 12 can be regarded as a configuration substantially including an Nd-M1 alloy, and the improvement effect of the electrical resistivity by diffusing the additive element M1 into the grain boundary phase 12 can be obtained. It is more preferable that the grain boundary phase 12 includes an Nd-M1 alloy in a proportion of equal to or greater than 90 atom %.

The Nd-M1 alloy constituting the grain boundary phase 12 has a composition represented by a composition formula: Nd₁₀₀₋ₓM1ₓ, and x is preferably greater than 0 and equal to or less than 50. When the additive element M1 of greater than 50 atom % is diffused into the sintered magnet, the additive element M1 easily enters the main phase 11. When the additive element M1 enters the main phase 11, the magnetic characteristics of the neodymium magnet 10 are greatly deteriorated.

The Nd-M1 alloy constituting the grain boundary phase 12 has a composition represented by a composition formula: Nd₁₀₀₋ₓM1ₓ, and x is preferably equal to or greater than 37.5 and equal to or less than 50. In the present example embodiment, the additive element M1 is Si or Ge, and the Nd-M1 alloy formed with the additive element M1 of equal to or less than 50 atom % includes six types of Nd₅Ge₃, Nd₅Ge₄, NdGe, Nd₅Si₃, Nd₅Si₄, and NdSi. When the content of the additive element M1 is equal to or more than 37.5 atom % and equal to or less than 50 atom %, it is considered that almost the entire amount of the additive element M1 in the grain boundary phase 12 is alloyed. This can promote isolation of the main phase 11, and also suppresses diffusion of the additive element M1 into the main phase 11, so that the neodymium magnet 10 having excellent magnetic characteristics can be obtained.

The neodymium magnet 10 may have a coating film including an Nd-M1 alloy on the surface. The neodymium magnet 10 of the present example embodiment is manufactured by bringing an Nd-M1 alloy into contact with the surface of a sintered magnet. The Nd-M1 alloy used in the manufacturing may be left on a part or the entirety of the surface of the sintered magnet. The surface of the neodymium magnet 10 may be further subjected to rust-preventive coating. After the Nd-M1 alloy present on the surface of the neodymium magnet 10 is removed by polishing, rust-preventive coating may be applied.

The present example embodiment may have a configuration in which the main phase 11 has a composition represented by a composition formula: Nd—(Fe,M2)-B, and an additive element M2 is at least one element selected from the group consisting of Al, Cr, and Mn. By adding the additive element M2 to the main phase 11, it is possible to further increase the electrical resistivity of the neodymium magnet 10.

The content of the additive element M2 is preferably in a range of equal to or greater than 1 atom % and equal to or less than 5 atom % when the total content of Fe and the additive element M2 is 100 atom %. That is, it is preferable that the main phase 11 containing the additive element M2 has a composition represented by a composition formula: Nd₂(Fe_{100-y},M2_{y})₁₄B, and y is equal to or greater than 1 and equal to or less than 5. By setting the content of the additive element M2 in the above range, it is possible to increase the electrical resistivity while suppressing the influence on the magnetic characteristics of the neodymium magnet 10.

Next, a manufacturing method of the neodymium magnet 10 according to the present example embodiment will be described.

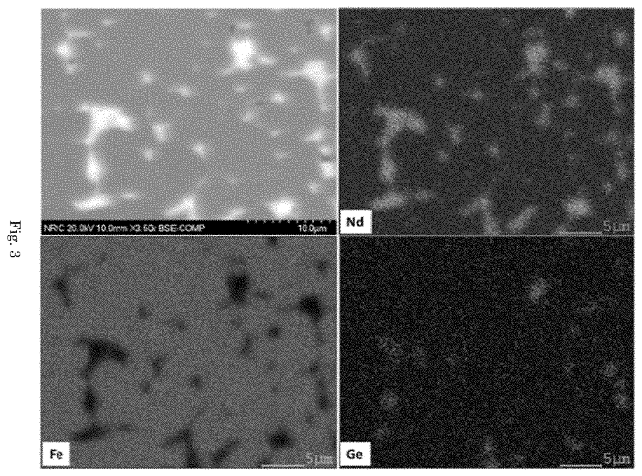

FIG. 2 is an explanatory view illustrating the manufacturing method of the neodymium magnet of the present example embodiment.

The manufacturing method of the neodymium magnet 10 of the present example embodiment includes a step of preparing a sintered magnet 10A having a material structure including the main phase 11 having a composition represented by a composition formula: Nd—Fe—B and a grain boundary phase 12A having an Nd concentration higher than that of the main phase 11, and a step of diffusing the additive element M1 into the grain boundary phase 12A of the sintered magnet 10A by heating the sintered magnet 10A and an Nd-M1 alloy 13 in a state where the Nd-M1 alloy 13 containing the additive element M1 is brought into contact with the surface of the sintered magnet 10A.

As the sintered magnet 10A, a known Nd—Fe—B sintered magnet can be used. That is, it is possible to use a sintered magnet having a structure in which the Nd-rich grain boundary phase 12A surrounds the main phase 11 including an Nd₂Fe₁₄B compound. The sintered magnet 10A may contain Dy and Tb in the magnet alloy by about several mass % to 10 mass %. Furthermore, as the sintered magnet 10A, a sintered magnet containing the additive element M2 including at least one element selected from the group consisting of Al, Cr, and Mn in the main phase 11 may be used.

The shape and size of the sintered magnet 10A are not particularly limited as long as the additive element M1 can be diffused throughout. If the sintered magnet 10A has a large thickness or a complicated shape, it takes time to diffuse the additive element M1, and the manufacturing efficiency decreases. When a plate-shaped magnet having a thickness of about 1 mm to several mm is used as the sintered magnet 10A, the reaction quickly proceeds in the thickness direction even if the plane area is large, so that the additive element M1 can be efficiently diffused in a short time.

In the step of diffusing the Nd-M1 alloy into the grain boundary phase 12A, the sintered magnet 10A and the Nd-M1 alloy 13 are reacted with each other in a state where the Nd-M1 alloy 13 is in contact with the surface of the sintered magnet 10A. As a specific reaction method, for example, a method can be used in which the sintered magnet 10A and the metal pieces or particles of the Nd-M1 alloy 13 are accommodated in a heating container such as a crucible and heated to a predetermined temperature. The heat treatment of the sintered magnet 10A and the Nd-M1 alloy 13 is preferably performed in vacuum or in an inert gas atmosphere to suppress generation of impurities such as oxides.

The manufacturing method of the neodymium magnet according to the present example embodiment forms a configuration in which in the process in which the additive element M1 adhering to the surface of the sintered magnet 10A diffuses and permeates into the sintered magnet 10A during the heat treatment, the additive element M1 is hardly replaced with Nd of the Nd₂Fe₁₄B main crystal of the main phase 11 and is selectively distributed in the grain boundary phase 12A. That is, according to the method of the present example embodiment, an alloy of Nd and the additive element M1 is formed in the grain boundary phase 12A.

According to the ternary phase diagram of Nd, Fe, and B, the two-phase mixed state of the Nd single phase and the Nd₂Fe₁₄B compound phase is stable. Therefore, no diffusion occurs between the Nd single phase and the Nd₂Fe₁₄B compound phase at equal to or less than a melting temperature (about 1000° C.) of the sintered magnet 10A at which the grain boundary phase 12A is liquefied. Therefore, in order to selectively diffuse the additive element M1 into the grain boundary phase 12A, the Nd-M1 alloy 13 is preferably an Nd-M1 alloy in which Nd is equal to or greater than 50 atom %.

In order to improve the diffusion rate, it is desirable that the diffusion element side is in a liquid state and the magnet side is in a solid state during the heat treatment. Therefore, it is preferable to select the composition of the Nd-M1 alloy that has a melting point of equal to or less than 1000° C. and becomes a liquid at a heat treatment temperature. When the additive element M1 is, for example, Ge, the composition having the lowest melting point shown in the Nd—Ge binary phase diagram is Nd₉₀Ge₁₀. Therefore, it is preferable to select Nd₉₀Ge₁₀ as the composition of the Nd—Ge alloy 13 to be used for manufacturing. Since the melting point of Nd₉₀Ge₁₀ is 825° C., the heat treatment temperature can be set to, for example, 850° C.

FIG. 3 shows element mapping of a sample obtained by disposing an Nd₉₀Ge₁₀ alloy around an Nd—Fe—B sintered magnet and performing heat treatment at 850° C. for two hours. In the description of FIG. 3, an upper side in an orientation of characters in the figure is defined as an upper side. In FIG. 3, the upper left view is a reflection electron image. In the reflection electron image, an element having a larger atomic number appears white. The grain boundary triple point at which the grain boundary phases intersect with each other appears white because of the presence of a large amount of Nd. In FIG. 3, the other three views are EDX analysis results. In the upper right view, a region where a large amount of Nd is present appears white. In the lower left view, a region where a large amount of Fe is present appears white. In the lower right view, a region where a large amount of Ge is present appears white. As shown in FIG. 3, Ge is detected at the grain boundary triple point. In this measurement, Ge is not detected from the main phase and the grain boundary phase other than the triple point due to the measurement limit, but since there is no concentration gradient in the region where Ge is detected, it is recognized that Ge is uniformly distributed in the grain boundary phase. On the other hand, in the main phase, Ge is not detected although the area is larger than that of the grain boundary triple point, and thus Ge is not diffused in the main phase.

According to the manufacturing method of the neodymium magnet of the present example embodiment, it is possible to uniformly diffuse the additive element M1 into the grain boundary phase 12A of the Nd—Fe—B sintered magnet 10A. This makes it possible to manufacture the neodymium magnet 10 of the present example embodiment having the grain boundary phase 12 substantially including the Nd-M1 alloy. According to the manufacturing method of the present example embodiment, a neodymium magnet having high electrical resistivity can be easily and efficiently manufactured using a known sintered magnet.

In the above method, the Nd-M1 alloy is supplied as metal pieces or particles, but the Nd-M1 alloy may directly adhere to the surface of the sintered magnet 10A. For example, after a slurry in which Nd-M1 alloy particles are dispersed is applied to the surface of the sintered magnet 10A, it may be dried to form a coating film including Nd-M1 alloy particles on the surface of the sintered magnet 10A. In this case, a binder that binds the Nd-M1 alloy particles may be used. As another method, it is also possible to adopt a method of forming a coating film of an Nd-M1 alloy on the surface of the sintered magnet 10A using a physical vapor deposition method such as a sputtering method.

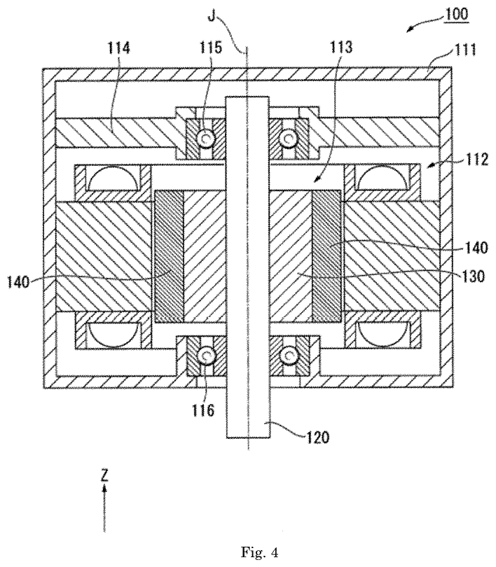

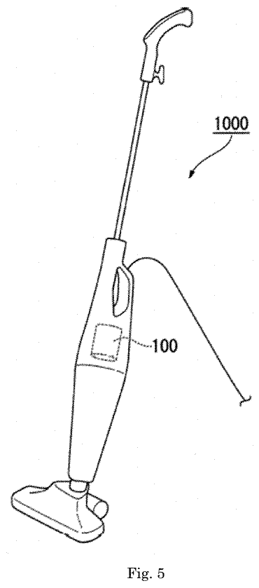

FIG. 4 is a cross-sectional view illustrating an example of the motor of the present example embodiment including the above-described neodymium magnet.

In FIG. 4, the direction parallel to a direction in which a central axis J extends is indicated by a Z axis. In the following description, the direction parallel to a direction in which the central axis J extends is simply referred to as an “axial direction”. The radial direction about the central axis J is simply referred to as a “radial direction” and the circumferential direction about the central axis J is simply referred to as a “circumferential direction”. The positive side in the Z axis direction is defined as an “upper side” and the negative side in the Z axis direction is defined as a “lower side”.

In the present example embodiment, the lower side corresponds to one side in an axial direction. The upper side corresponds to the other side in the axial direction. Note that the upper side and the lower side are simply terms for describing the relative positional relationship of components, and the actual arrangement relationship and the like may be an arrangement relationship and the like other than the arrangement relationship and the like indicated by these terms.

A motor 100 of the present example embodiment includes a housing 111, a stator 112, a rotor 113 including a shaft 120 arranged along the central axis J extending in one direction, a bearing holder 114, and bearings 115 and 116. The housing 111 has a cylindrical shape with a bottom. The housing 111 accommodates the stator 112, the rotor 113, the bearing holder 114, and the bearings 115 and 116.

The stator 112 faces the rotor 113 radially via a gap radially outside the rotor 113. That is, the motor 100 of the present example embodiment is an inner rotor type motor in which the rotor 113 is positioned radially inside the stator 112. The motor 100 may be an outer rotor type motor in which the rotor is positioned radially outside the stator.

The shaft 120 is rotatably supported by the bearings 115 and 116. The bearings 115 and 116 are, for example, ball bearings. The bearing 115 is held by the bearing holder 114. The bearing 116 is held at the bottom of the housing 111. The shaft 120 has a columnar shape extending in the axial direction about the central axis J.

The rotor 113 includes the shaft 120, a rotor core 130 fixed to the shaft 120, and a neodymium magnet 140 fixed to the rotor core 130. The rotor core 130 has a pillar-like shape extending in the axial direction. Although not illustrated, the rotor core 130 includes, for example, a plurality of plate members laminated in the axial direction. The plate members constituting the rotor core 130 are electromagnetic steel plates, for example.

In the case of the present example embodiment, the neodymium magnet 140 is positioned radially outside the rotor core 130. That is, the motor 100 is a surface permanent magnet motor (SPM motor). In the motor 100, the neodymium magnet 140 may be positioned inside the rotor core 130. That is, the motor 100 may be an interior permanent magnet motor (IPM motor).

The neodymium magnet 140 is the neodymium magnet of the above-described example embodiment having the crystal structure illustrated in FIG. 1. In the motor 100 of the present example embodiment, since the electrical resistivity of the neodymium magnet 10 used in the rotor 113 is high, a current hardly flows through the neodymium magnet 10 during operation. This can reduce the eddy current loss. This can improve the motor efficiency, and can downsize the motor 100 as long as the motor efficiency is the same.

According to the motor 100 of the present example embodiment, it is possible to achieve a high-efficiency high-speed rotary motor. According to the present example embodiment, it is possible to achieve a motor in which the rotor 113 is rotatable at equal to or greater than 700 Hz, a motor in which the rotor 113 is rotatable at equal to or greater than 1000 Hz, and a motor in which the rotor 113 is rotatable at equal to or greater than 1500 Hz. In high-speed rotation such as rotation of equal to or greater than 700 Hz, an increase in eddy current loss generated in the magnet greatly affects the efficiency of the motor. Since the motor 100 of the present example embodiment includes the neodymium magnet 10 having a high resistivity, an increase in eddy current loss can be suppressed even in the rotor 113 rotating at a high speed as described above.

In the present example embodiment, the neodymium magnet 140 may be divided into a plurality of magnet pieces along the axial direction. The plurality of divided magnet pieces may form the same magnetic pole. According to this configuration, since the path through which the eddy current flows is shortened inside the neodymium magnet 140, the eddy current loss can be reduced. The neodymium magnet 140 is preferably divided into a plurality of magnet pieces along the axial direction. In the present example embodiment, the neodymium magnet 140 may be a plurality of segment-type magnets arranged in the circumferential direction about the central axis J, or may be a cylindrical ring-type magnet about the central axis J.

In the present example embodiment, the case where the motor 100 is a brushless motor including the neodymium magnet 10 in the rotor 113 has been described, but the motor 100 may be a brushed motor including the neodymium magnet 10 in the stator. The brushed motor 100 may be an inner rotor type or an outer rotor type.

The application of the motor 100 to which the present disclosure is applied is not particularly limited. The motor 100 of the present example embodiment is used, for example, in a drive system including the motor 100 as a rotor. By including the high-efficiency motor 100, it is possible to reduce power consumption and downsize the drive system.

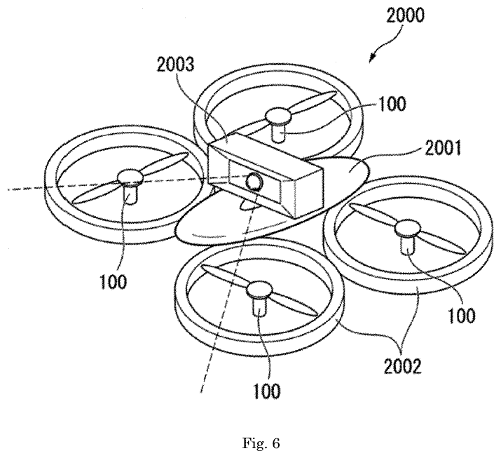

The motor 100 of the present example embodiment is used, for example, in a vacuum cleaner. FIG. 5 is a perspective view illustrating an example of a vacuum cleaner 1000. The vacuum cleaner 1000 includes the motor 100 of the above example embodiment as a motor that drives an impeller that generates wind for sucking dust. By including the high-efficiency motor 100, it is possible to increase the suction force, reduce power consumption, and downsize the vacuum cleaner 1000.

The motor 100 of the present example embodiment is used, for example, in an unmanned flight vehicle. FIG. 6 is a perspective view illustrating an example of an unmanned flight vehicle 2000. The unmanned flight vehicle 2000 includes a body 2001, a rotary blade 2002, an image-capturing device 2003, and the motor 100. The motor 100 rotationally drives the rotary blade 2002. Since the unmanned flight vehicle 2000 includes the motor 100, it is small in size and low in power consumption. The flight vehicle including the motor 100 of the present example embodiment is not limited to an unmanned flight vehicle, and may be an electric aircraft having a passenger seat.

The motor 100 of the present example embodiment can be used as, for example, a motor for driving an axle mounted on a vehicle, gear selection of a transmission such as a dual clutch transmission mounted on a vehicle, or a motor for driving a clutch. Use of the motor 100 of the present example embodiment can achieve downsizing and low heat generation of a motor for vehicle.

The motor 100 of the present example embodiment is used for, for example, a robot. The motor 100 can be used to drive a hand, an arm, and the like of the robot. Use of the motor 100 makes it possible to provide a robot in a small size with high output.

### Examples

As a sintered magnet, an Nd—Fe—B magnet having a length of 11 mm, a width of 3 mm, and a thickness of 1.5 mm was prepared. As an Nd—Ge alloy used for Ge diffusion, an Nd—Ge alloy having a composition of Nd₉₀Ge₁₀ was prepared. The Nd—Ge alloy was prepared by weighing an Nd raw material powder and a Ge raw material powder according to a composition ratio, and then melting the mixed raw material powder using an arc melting furnace. The weight of the Nd—Ge alloy was 0.7 g.

The step of diffusing the additive element M1 was performed by a method in which the Nd—Fe—B magnet and the Nd—Ge alloy were placed into a crucible and reacted in the crucible by heat treatment. The Nd—Fe—B magnet with a surface not covered and the Nd—Ge alloy produced in the above were placed into an alumina crucible having an inner diameter of 4 mmφ, and sealed together with the crucible in a glass tube having an inner diameter of 13 mmφ substituted with argon gas for oxidation prevention. The sealed sample was heat-treated at a temperature of 850° C. for 2 hours in a muffle furnace to obtain a neodymium magnet with diffused Ge. The treated sample was cut into a length of 7 mm, a width of 2.5 mm, and a thickness of 1 mm, and then a voltage/current terminal was attached, and the electric resistance was measured by a direct-current four-terminal method. The electrical resistivity was calculated by multiplying the obtained electrical resistance value by (cross-sectional area of sample/distance between voltage terminals). Subsequently, a pulse BH tracer of 12 T was used to measure a hysteresis loop of an applied magnetic field ±3 T. The sample dimension is the same as that in the electrical resistance measurement. Table 1 shows the measurement results of the electrical resistivity and the magnetic characteristics.

The neodymium magnet was produced with the additive element M1 as Si. A neodymium magnet with diffused Si was produced in the same manner as in Example 1 except that an Nd—Si alloy represented by the composition formula Nd₈₇Si₁₃ was used as the diffusion alloy. For the obtained neodymium magnet, electric resistance and magnetic characteristics were measured in the same manner as in Example 1. The measurement results are shown in Table 1.

The neodymium magnet in Comparative Example is the same magnet as the Nd—Fe—B magnet prepared as a sintered magnet of the raw material in Example 1. Also for the neodymium magnet in Comparative Example, electric resistance and magnetic characteristics were measured by the same method as in Example 1. The measurement results are shown in Table 1.

As shown in Table 1, it was confirmed that the neodymium magnet in Example 1 with diffused Ge and the neodymium magnet in Example 2 with diffused Si had an electrical resistivity improved by up to two times as compared with the neodymium magnet in Comparative Example with non-diffusion. The neodymium magnet in Example 1 had magnetic characteristics equivalent to those of the neodymium magnet in Comparative Example. The neodymium magnet in Example 2 had a higher coercivity than that of the neodymium magnet in Comparative Example. From the above results, it was found that the efficiency of the motor can be improved by using the neodymium magnet according to the present disclosure for the motor.

TABLE 1

| | | Heat | | Residual | Coer- |
|---|---|---|---|---|---|
| | Grain | treatment | Electrical | magnetic | civity |
| | boundary | temperature | resistivity | flux density | (kA/ |
| | phase | (° C.) | (μΩm) | (T) | m) |
| Example 1 | Nd—Ge | 850 | 2.90 | 1.23 | 590 |
| Example 2 | Nd—Si | 850 | 2.80 | 1.20 | 948 |
| Comparative | Nd | 850 | 1.45 | 1.30 | 590 |
| Example | | | | | |

In the second example, motor performance was analyzed for motors produced using neodymium magnets having different electrical resistivities. The motor performance was analyzed by a finite element method for each of cases where the motor configuration was a three-phase motor with two poles and three slots, and the electrical resistivities of the rotor magnet were 1.4 [μΩm], 2.0 [μΩm], and 2.8 [μΩm] under the conditions of the input voltage of 21.384 V and a rotation speed of 10,000 rpm. The measurement results are illustrated in Table 2.

TABLE 2

| | | | | | | |
|---|---|---|---|---|---|---|
| Electrical resistivity | 1.4 | μΩm | 2.0 | μΩm | 2.8 | μΩm |
| Eddy current loss | 2.0 | W | 1.3 | W | 1.0 | W |

As shown in Table 2, it was confirmed that the eddy current loss can be greatly reduced by increasing the electrical resistivity in the motor having a common configuration except the rotor magnet. That is, it is possible to reduce the eddy current loss as compared with the conventional neodymium magnet by increasing the electrical resistivity to equal to or greater than 1.5 μΩm by diffusing the additive element M1 in the grain boundary.

Torque and output other than the eddy current loss were equivalent among the three types of motors.

From the results of the second example, for example, use of the neodymium magnet having the Nd—Si grain boundary phase of Example 2 in the first example can reduce the eddy current loss to half as compared with the motor using the neodymium magnet of Comparative Example. That is, use of the neodymium magnet of Example 2 enables more current to flow through the coil of the motor, and therefore enables the output of the motor to greatly increase.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-18. (canceled)

19. A motor comprising:
a stator; and
a rotor rotatable about a central axis with respect to the stator, the rotor or the stator including a neodymium magnet; wherein
the neodymium magnet includes a material structure including a main phase with a composition represented by a composition formula: Nd—Fe—B and a grain boundary phase including an Nd concentration higher than an Nd concentration of the main phase;
the grain boundary phase includes at least an alloy of Nd and an additive element M1;
the additive element M1 is an element other than Fe and B; and
an electrical resistivity of the neodymium magnet is equal to or greater than about 1.5 μΩm.

20. The motor according to claim 19, wherein the additive element M1 is at least one element selected from a group consisting of Si and Ge.

21. The motor according to claim 19, wherein the grain boundary phase includes an alloy of Nd and an additive element M1 in a proportion of equal to or greater than about 85 atom %.

22. The motor according to claim 19, wherein
the alloy defining the grain boundary phase includes a composition represented by a composition formula: Nd₁₀₀₋ₓM1ₓ, where x is greater than 0 and equal to or less than about 50.

23. The motor according to claim 19, wherein
the alloy defining the grain boundary phase includes a composition represented by a composition formula: Nd₁₀₀₋ₓM1ₓ, where x is equal to or greater than about 37.5 and equal to or less than about 50.

24. The motor according to claim 19, wherein
the main phase includes a composition represented by a composition formula: Nd—(Fe,M2)-B, where the additive element M2 is at least one element selected from a group consisting of Al, Cr, and Mn.

25. The motor according to claim 24, wherein
a content of the additive element M2 is equal to or greater than about 1 atom % and equal to or less than about 5 atom % when a total content of Fe and the additive element M2 is 100 atom %.

26. The motor according to claim 19, wherein the rotor is rotatable at equal to or greater than about 700 Hz.

27. The motor according to claim 19, wherein the rotor is positioned radially outside the stator.

28. The motor according to claim 19, wherein the rotor is positioned radially inside the stator.

29. The motor according to claim 19, wherein
the neodymium magnet is divided into magnet pieces along an axial direction.

30. The motor according to claim 19, wherein the rotor includes a rotor core and the neodymium magnet fixed to the rotor core.

31. The motor according to claim 30, wherein the neodymium magnet is positioned inside the rotor core.

32. The motor according to claim 30, wherein the neodymium magnet is positioned radially outside the rotor core.

33. A drive system comprising the motor according to claim 19 defining a rotor.

34. A vacuum cleaner comprising the motor according to claim 19.

35. An unmanned flight vehicle comprising the motor according to claim 19.

36. An electric aircraft comprising the motor according to claim 19.
